(19) United States
(12) Patent Application Publication
(10) Pub. No.: US 2026/0235181 A1
(43) Pub. Date: Aug. 13, 2026

(54) GAS SPRING SYSTEM HAVING AT LEAST ONE GAS SPRING

(71) Applicant: Stabilus GmbH, Koblenz (DE)

(72) Inventors: Michael Hewel, Boppard Udenhausen (DE); Michael Schneider, Ochtendung (DE); Rolf Stumm, Koblenz (DE)

(21) Appl. No.: 19/153,546

(22) PCT Filed: Feb. 9, 2024
(86) PCT No.: PCT/EP2024/053393

§ 371 Date: Aug. 4, 2025

(30) Foreign Application Priority Data
Feb. 11, 2023 (DE) 10 2023 000 433.2

(51) Int. Cl. F16F 9/02; F16F 9/346; F16F 9/36

(52) U.S. Cl. CPC F16F 9/0245; F16F 9/346; F16F 9/368

(57) ABSTRACT

The invention relates to a gas spring system having at least one gas spring (1) with a piston arrangement (3) arranged in a displaceable manner in the cylinder. The piston arrangement (3) is designed as a piston packet that is closed depending on direction, wherein the piston packet is designed in a springless manner and has at least one annular sealing element (12) which is provided for sealing between the retaining region (10) of the cylinder (2) and the piston arrangement (3) during a push-out movement of the gas spring (1), and wherein the sealing element (12) is arranged and displaceable in a radially outer annular space (23) of the piston packet such that the sealing element (12) can be pressed against the cylinder (2) with a first pressing force during a push-out movement of the gas spring (1), and can be pressed against the cylinder (2) with a second, lower pressing force during a push-in movement of the gas spring (1).

The invention relates to a gas spring system having at least one gas spring with a cylinder closed at a first end, a piston arrangement displaceably arranged in the cylinder, which arrangement divides the cylinder into a first working chamber near the first end and a second working chamber remote from the first end, and a piston rod arranged on one side of the piston arrangement, which rod projects through the second working chamber and is led out of the cylinder concentrically to the longitudinal axis of the cylinder at a second end opposite the first end, sealed by a seal and a piston rod guide.

Gas spring systems with a gas spring are well known. Gas springs are used in particular for power support, but also for damping and locking. In addition to lifting, they can also be used to specifically dampen a movement at a defined speed. Gas spring systems are used, for example, in flap systems with two end positions, such as with vehicle tailgates which need to be easily adjusted from the closed to an open position. Depending on the application, the limitation of a flap opening angle or the provision of different flap opening angles is desired.

The gas springs known for these applications usually have a piston valve acting depending on the direction with a piston seal, which valve is closed by a spring force during an automatic extension movement of the gas spring and opens in a retaining region due to a force acting in the opening direction depending on the pressure. This piston seal with the spring-loaded valve, known for example from DE 33 01 544 A1 , has proven to be disadvantageous, in particular with regard to frictional resistance and temperature dependence. Likewise, the use of a piston valve can be disadvantageous with regard to noise emissions.

A gas spring with a springless piston packet is known, for example, from DE 25 13 302A1 . In this regard, high friction of the sealing elements has proven to be disadvantageous.

Therefore, it is an object of the invention to propose a gas spring system improved in this regard having at least one simply constructed gas spring.

The object is achieved according to the invention by a gas spring system according to claim 1. The gas spring system according to the invention comprises at least one gas spring system having at least one gas spring with a cylinder closed at a first end, a piston arrangement displaceably arranged in the cylinder, which arrangement divides the cylinder into a first working chamber near the first end and a second working chamber remote from the first end, and a piston rod arranged on one side of the piston arrangement, which rod projects through the second working chamber and is led out of the cylinder concentrically to the longitudinal axis of the cylinder at a second end opposite the first end that is sealed by a seal and a piston rod guide. The cylinder has at least one overflow channel which can be connected to the working spaces for the automatic push-out movement of the gas spring, wherein at least one retaining region of the cylinder which interrupts the overflow channel is provided for limiting the stroke of the piston arrangement and in which the automatic push-out movement is blocked. The piston arrangement is designed as a piston packet that is closed depending on the direction. Furthermore, the piston packet is designed without springs and has at least one annular sealing element which is provided for sealing between the retaining region of the cylinder and the piston arrangement during a push-out movement of the gas spring. The sealing element is arranged and displaceable in a radially outer annular space of the piston packet such that the sealing element can be pressed against the cylinder with a first pressing force during a push-out movement of the gas spring, and can be pressed against the cylinder with a second, lower pressing force during a push-in movement of the gas spring.

In this context, a piston packet closed depending on the direction means that no additional force, such as a spring force, is required to close the piston packet during a push-out movement. By eliminating a valve spring, the design of the piston packet can be significantly simplified, which optimizes the cost of the gas spring system and reduces design effort due to the significantly simplified design.

The gas spring system is also less dependent on temperature due to the elimination of the valve spring. In known gas springs with valve springs, the retaining force decreases with increasing temperature. To compensate for this, it is therefore necessary to use a stronger valve spring, which in turn leads to increased adjustment forces at medium and in particular at lower temperatures.

In the gas spring with the piston packet according to the invention, the push-out force increases with increasing temperature, but at the same time the retaining force of the piston packet increases so that compensation in this regard is not necessary.

A reduced pressing force of the sealing element during a push-in movement also leads to a reduction in friction.

The system according to the invention accordingly allows for improved adjustment comfort, in particular in the medium and lower temperature range, due to a smaller spread of an adjustment force.

According to an advantageous embodiment of the invention, the piston packet has a further sealing element which is provided for static sealing between the piston arrangement and the piston rod.

These two annular sealing elements allow for one-or two-sided static sealing as well as a gas-tight design of the piston packet, which can result in lower friction of the sealing elements.

A particularly simple construction of the piston packet is preferably achieved in that the piston packet has a piston and a stop disk, wherein the piston rests against the stop disk with a projection extending in the axial direction relative to the longitudinal axis in such a way that the radially outer annular space is formed.

The stop disk rests on a shoulder of the piston rod, wherein a piston rod extension protrudes through the piston packet and attaches the piston packet to the piston rod.

The stop disk is preferably substantially cylindrical and has a radial collar which rests on the shoulder of the piston rod and which has at least one radially outer recess, wherein the piston rests with the projection on a side of the collar facing away from the piston rod.

Preferably, the piston has an annular recess for receiving the further annular sealing element for sealing the piston relative to the piston rod.

If, during the push-out movement, the piston packet reaches the retaining region of the cylinder interrupting the at least one overflow channel, a seal between the piston and piston rod or between the piston and cylinder is thereby easily ensured.

The projection tapers on its outer side in such a way that the sealing element is displaced in the direction of the piston during a push-out movement and a sealing contact with the retaining region of the cylinder interrupting the overflow channel is ensured. During a push-in movement, the sealing element moves in the direction of the collar of the stop disk so that overflow is possible. The tapering of the projection advantageously reduces the pressing force of the sealing element against the cylinder and accordingly the frictional force.

Preferably, the collar has a knob structure on the side facing away from the piston rod. On the one hand, these knobs are easy to flow over and ensure pre-positioning of the sealing element in the direction of the piston. A flow through the recess of the stop disk can be easily ensured.

According to an advantageous design of the invention, the at least one overflow channel is designed as an axial groove, wherein the groove profile is provided for adapting a stroke-dependent controllable push-out speed. For example, a flat start of the automatic push-out movement of the gas spring can be realized.

Preferably, at least two overflow channels are provided and designed as an axial groove, wherein the retaining region of the cylinder interrupting the overflow channels is provided for adjusting the stroke limitation. This allows several opening angles to be realized when used for a flap system.

According to an advantageous embodiment of the gas spring system, it comprises a further gas spring. Depending on the application, the two gas springs can have an identical or a differently constructed piston packet or differ in the design of the overflow channels.

The gas spring system according to the invention can preferably be used for a flap system, in particular a tailgate system. It can also be used for a front hood system.

### BRIEF DESCRIPTION OF THE DRAWINGS

Further advantages are shown in the following drawing description. An embodiment of the invention is shown in the drawings. The drawings, the description, and the claims contain numerous features in combination. A person skilled in the art will expediently also consider the features individually and combine them to form expedient further combinations.

In the following examples:

FIG. 1 shows a gas spring of a gas spring system according to the invention in longitudinal section;

FIG. 2 shows a push-out force characteristic of the gas spring according to FIG. 1.

### EMBODIMENT OF THE INVENTION

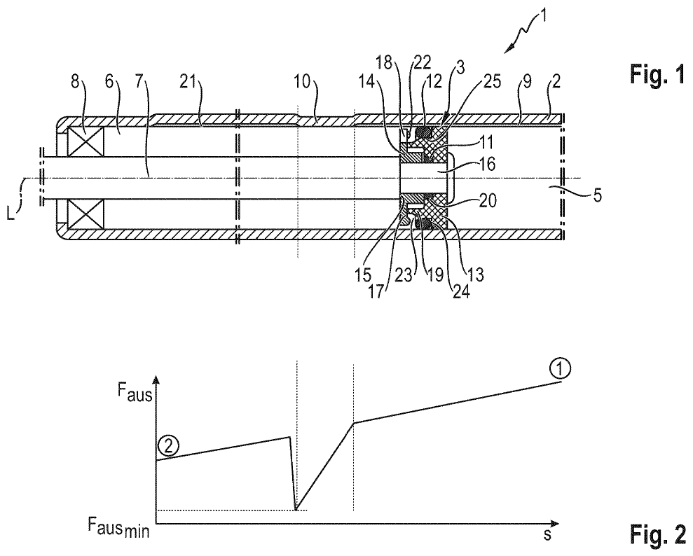

FIG. 1 shows a detail of a gas spring 1 of a gas spring system according to the invention in longitudinal section. The gas spring system can preferably be used for a flap system (not shown), in particular a tailgate system. It can also be used for a front hood system.

The gas spring 1, which is shown in a not completely inserted state, comprises a cylinder 2 closed at a first end (not shown) as well as a piston arrangement 3 displaceably arranged in the cylinder 2 which divides the cylinder 2 filled with compressed gas into a first working chamber 5 near the first end and a second working chamber 6 remote from the first end. A piston rod 7 arranged on one side of the piston arrangement 3 and which projects through the second working chamber 6 is led out of the cylinder 2 concentrically to the longitudinal axis L of the cylinder 2 or the gas spring 1 at a second end 4 opposite the first end that is sealed by a seal 8 and a piston rod guide (not shown in detail). The cylinder 2 has at least one overflow channel 9 connectable to the working chambers 5, 6 for the automatic push-out movement of the gas spring. If the piston arrangement 3 is located in this region of the cylinder 2, the overflow results in dynamic damping of the push-out movement. If the piston arrangement 3 reaches a retaining region 10 of the cylinder 2 interrupting the overflow channel 9 during the course of the movement, the automatic push-out movement of the piston arrangement 3 is blocked. In other words, the retaining region 10 of the cylinder 2, which region is illustrated by means of two dashed lines, is provided for limiting the stroke of the piston arrangement 3.

If a further overflow channel 21 is provided as shown, a second region with automatic push-out movement follows the retaining region 10 during the further course of the push-out movement.

The piston arrangement 3 is designed as a springless piston packet that is closed depending on the direction. In this context, a piston packet closed depending on the direction means that no additional force, such as a spring force, is required to close the piston packet during a push-out movement. By eliminating a known valve spring, the design of the piston packet can be significantly simplified, which optimizes the cost of the gas spring system and reduces design effort due to the significantly simplified design. Likewise, the gas spring system is more temperature-independent due to the elimination of the valve spring, so that an overall improved adjustment comfort can be achieved due to a smaller spread of the adjustment force, in particular in the medium and lower temperature range.

As can be seen from FIG. 1, the piston packet has an annular 12 as well as a further sealing element 11 which are provided during a push-out movement in the retaining region 10 of the cylinder 2 interrupting the overflow channels 9, 21 for sealing between the cylinder 2 and the piston packet as well as between the piston packet and the piston rod 7. The piston packet comprises a piston 13 as well as a stop disk 14, wherein the stop disk 14 rests against a shoulder 15 of the piston rod 7, a piston rod extension 16 pushes out through the piston packet and additionally fastens the piston packet to the piston rod 7, for example by riveting. Together with the piston arrangement 3, the piston rod 7 forms a piston-piston rod unit.

The piston 13 can advantageously be made of plastics material.

The stop disk 14 is, as can be seen from FIG. 1, substantially cylindrical and has a radial collar 17 which rest against the shoulder 15 of the piston rod 7 and has at least one radially outer recess 18. The piston 13 rests with a projection 19 extending in the axial direction—relative to the longitudinal axis L of the gas spring 1 or the cylinder 2—on a side of the collar 17 facing away from the piston rod 7.

Furthermore, the piston 13 has a radially inner, annular recess 20 for receiving the further annular sealing element 11 for sealing the piston 13 against the piston rod 7 or the piston rod extension 16 and forms, with its projection 19 and the collar 17 of the stop disk 14, a radially outer annular space 23 for receiving the annular sealing element 12. If the piston packet reaches the retaining region 10 of the cylinder 2 interrupting the overflow channels 9, 21 during the push-out movement, a seal between the piston 13 and the piston rod extension 16 or between the piston 13 and the cylinder 2 is thereby ensured in a simple manner.

The sealing element 12 is arranged and displaceable in the radially outer annular space 23 such that it can be pressed against the cylinder 2 with a first pressing force during a push-out movement of the gas spring 1 and can be pressed against the cylinder 2 with a second, lower pressing force during a push-in movement of the gas spring 1. The first pressing force is significantly higher, for example at least twice as large as the second pressing force.

For this purpose, the projection 19 tapers on its outer side in such a way that the sealing element 12 is displaced in the direction of the piston 13 during a push-out movement and a sealing contact with the retaining region 10 of the cylinder interrupting the overflow channels 9, 21 is ensured. As can be seen from FIG. 1, the sealing element 12 rests against a radial and an axial piston surface 24, 25 of the piston 13 with a high contact pressure.

During a push-in movement, the sealing element 12 is displaced in the direction of the collar 17 of the stop disk 14 so that an overflow over the sealing element 12 from the working chamber 5 in the direction of the working chamber 6 is possible. Since the sealing element 12 no longer sealingly rests against the radially and axially formed piston surfaces 24, 25, the gas can in this case flow between the piston 3 and sealing element 12 and enters into the working chamber 6 via the recess 18.

The displacement of the sealing element 12 in the direction of the stop disk 14 results in a reduced pressing force of the sealing element 12 on the cylinder 2 so that a significantly lower friction here is the result.

On the one hand, a flow can easily flow over a knob structure with knobs 22 on the side of the collar 17 facing away from the piston rod 7, and it ensures pre-positioning of the sealing element 12 in the direction of the piston 13. In other words, the knobs 22 prevent an excessive displacement of the sealing element 12 in the direction of the stop disk 14. Sealing of the recess 18 can be reliably prevented.

The overflow channels 9, 21 are designed as axial grooves in the shown embodiment, wherein the groove course is provided for adapting a stroke-dependent controllable discharge speed. For example, a flat start of the automatic push-out movement of the gas spring 1 can be realized. Other groove profiles (not shown) are also conceivable within the scope of the invention. By providing two overflow channels 9, 21 with an intermediate retaining region 10 which interrupts the overflow channels 9, 21, for example, two opening angles of the flap system can be realized.

FIG. 2 shows a push-out force characteristic of the gas spring 1, wherein at a first point 1 of the characteristic curve the piston rod 7 is pushed in with the piston packet, i.e., in the drawing it is in a right end position. In this state, a tailgate hinged to the gas spring, for example, is closed. Upon opening the tailgate, the piston packet is initially located in the region of the first overflow channel 9, and gas flows over the groove of the first overflow channel 9 from the second working chamber 6 into the first working chamber 5. Since a filling pressure is selected such that the weight of the tailgate is overcome, the gas spring 1 pushes out automatically. The push-out force Faus decreases linearly until the piston packet reaches the retaining region 10 at which a first opening angle of the tailgate is reached. In this region, the piston packet is statically sealed so that the retaining or stopping function of the tailgate is ensured. The push-out force Faus drops to a minimum due to the gas compression.

If the tailgate is to be opened further, the gas spring 1 or its piston-piston rod unit can usually be brought manually into the region of the second overflow channel 21 by means of an adjustable release force, so that the piston rod 7 pushes out again automatically until a left end position shown in the drawing with the point 2 is reached, in which position a second opening angle of the tailgate is reached.

The gas spring 1 and accordingly the gas spring system shows significantly improved temperature behavior. In order to overcome the triggering force or overpressure force, the piston-piston-rod unit must be displaced against a pressure cushion building up in the second working chamber 6 until the sealing element 12 reaches the region of the second overflow channel 21 and the pressure cushion above it can be reduced.

When the piston packet is moved, the second working chamber 6 in front of the piston packet becomes smaller and the pressure continues to rise. The increase corresponds to the ratio of the volume upon reaching the retaining region 10 to the volume upon reaching the end of this region. If the starting pressure increases due to an increase in temperature, the absolute pressure increase at the end will be greater than with a low starting pressure. This effect counteracts the decreasing overpressure force at a higher temperature by increasing the extension force and can neutralize this undesirable effect.

A gas spring system according to the invention can comprise the described gas spring 1 as well as a further gas spring. The further gas spring can be constructed identically to the gas spring 1. Alternatively, the further gas spring can be designed differently from the gas spring 1 and, for example, have a non-static seal and/or a reduced groove cross section and/or only a travel-dependent damping.

To improve the frictional resistance, the further gas spring can have a piston packet with a piston ring which has improved sliding properties. For example, a PTFE ring can be used here. In this case, the retaining function would be ensured exclusively by the gas spring 1 described above.

1. A gas spring system having at least one gas spring with a cylinder closed at a first end, a piston arrangement displaceably arranged in the cylinder, which arrangement divides the cylinder into a first working chamber near the first end and a second working chamber remote from the first end, and a piston rod arranged on one side of the piston arrangement, which rod projects through the second working chamber and is led out of the cylinder concentrically to the longitudinal axis (L) of the cylinder at a second end opposite the first end, sealed by a seal and a piston rod guide, wherein the cylinder has at least one overflow channel connectable to the working chambers for the automatic push-out movement of the gas spring wherein at least one retaining region of the cylinder which interrupts the overflow channel is provided for limiting the stroke of the piston arrangement in which the automatic push-out movement is blocked, wherein the piston arrangement is designed as a piston packet that is closed depending on direction, wherein the piston packet is designed in a springless manner and has an annular sealing element which is provided for sealing between the retaining region of the cylinder and the piston arrangement during a push-out movement of the gas spring wherein the piston packet has a further annular sealing element, which is provided for static sealing between piston arrangement and piston rod, and wherein the sealing element is arranged and displaceable in a radially outer annular space of the piston packet such that the sealing element can be pressed against the cylinder with a first pressing force during a push-out movement of the gas spring, and can be pressed against the cylinder with a second, lower pressing force during a push-in movement of the gas spring, wherein the piston packet has a piston and a stop disk and the piston, with a projection extending in the axial direction relative to the longitudinal axis (L), rests against the stop disk in such a manner as to form the radially outer annular space.

2. (canceled)

3. (canceled)

4. The gas spring system according to claim 1, wherein in that the stop disk rests against a shoulder of the piston rod, wherein a piston rod extension projects through the piston packet and fastens the piston packet to the piston rod

5. The gas spring system according to claim 4, wherein in that the stop disk is substantially cylindrical and has a radial collar which rests against the shoulder of the piston rod and which has at least one radially outer recess, wherein the piston rests with the projection on a side of the collar facing away from the piston rod.

6. The gas spring system according to claim 5, wherein the piston has an annular recess for receiving the further annular sealing element for sealing the piston relative to the piston rod.

7. The gas spring system according to claim 6, wherein the collar has a knob structure on the side facing away from the piston rod.

8. The gas spring system according to claim 7, wherein the at least one overflow channel is designed as an axial groove, wherein the groove profile is provided for adapting a stroke-dependent controllable push-out speed.

9. The gas spring system according to claim 8, wherein at least two overflow channels are provided and are designed as an axial groove, wherein the retaining region of the cylinder interrupting the overflow channels is provided for adjusting the stroke limitation.

10. The gas spring system according to claim 1, wherein the gas spring system comprises a further gas spring.

11. The gas spring system according to claim 10, wherein the gas springs have an identical or a differently constructed piston packet.

12. The gas spring system according to claim 10, wherein the gas springs have differently designed overflow channels.

13. The gas spring system according to claim 1 for use for a flap system.
